(19) United States
(12) Patent Application Publication
(10) Pub. No.: US 2013/0184848 A1
(43) Pub. Date: Jul. 18, 2013

(54) Retrofitting Cleanroom Fabricators into Cleanspace Fabricators

(71) Applicant: Frederick A. Flitsch, New Windsor, NY (US)

(72) Inventor: Frederick A. Flitsch, New Windsor, NY (US)

(21) Appl. No.: 13/734,991

(22) Filed: Jan. 6, 2013

Related U.S. Application Data
(60) Provisional application No. 61/585,951, filed on Jan. 12, 2012.

(51) Int. Cl. G06F 17/50

(52) U.S. Cl. CPC G06F 17/50
USPC 700/112

(57) ABSTRACT

The present invention provides various methods for forming cleanspace fabricators by retrofitting a structure of an existing cleanroom based fabricator. In some embodiments, a cleanspace fabricator is formed within a region of a cleanroom fabricator which is not transformed.

### CROSS REFERENCE TO RELATED APPLICATIONS

This application claims priority to United States Provisional Patent Application bearing the Ser. No. 61/585951, filed Jan. 12, 2012, entitled Retrofitting Cleanroom Fabricators into Cleanspace Fabricators. This application is a continuation-in part to the United States Patent Applications bearing the Ser. No. 11/933,280 filed Oct. 31, 2007 and entitled Method and Apparatus for a Cleanspace Fabricator; and Ser. No. 11/520975, filed Sep. 14, 2006 and entitled Method and Apparatus for Vertically

Orienting Substrate Processing Tools in a Cleanspace; and Ser. No. 11/502,689 filed Aug. 12, 2006 and entitled Method and Apparatus to Support a Cleanspace Fabricator and to any divisional or continuation patents thereto. The contents of each are relied upon and incorporated by reference.

### FIELD OF THE INVENTION

The present invention relates to apparatus and methods which are useful in transforming cleanroom fabricators into cleanspace fabricators. The field of the invention therefore also includes the various diversity of cleanspace fabricators which may be created in this manner.

### BACKGROUND OF THE INVENTION

A known approach to advanced technology fabrication of materials, such as semi-conductor substrates, is to assemble a manufacturing facility as a “cleanroom.” In such cleanrooms, processing tools are arranged to provide aisle space for human operators or automation equipment. Exemplary cleanroom design is described in: “Cleanroom Design, Second Edition,” edited by W. Whyte, published by John Wiley & Sons, 1999, ISBN 0-471-94204-9, (herein after referred to as “the Whyte text”).

Cleanroom design has evolved over time from an initial starting point of locating processing stations within clean hoods. Vertical unidirectional airflow can be directed through a raised floor, with separate cores for the tools and aisles. It is also known to have specialized mini-environments which surround only a processing tool for added space cleanliness. Another known approach includes the “ballroom” approach, wherein tools, operators and automation all reside in the same cleanroom.

Evolutionary improvements have enabled higher yields and the production of devices with smaller geometries. However, known cleanroom design has disadvantages and limitations.

For example, as the size of tools has increased and the dimensions of cleanrooms have increased, the volume of cleanspace that is controlled has concomitantly increased. As a result, the cost of building the cleanspace, and the cost of maintaining the cleanliness of such cleanspace, has increased considerably. Not all processing steps, like for example, the steps used to assembly products into their packaging, need to occur in the developing large processing environments.

### SUMMARY OF THE INVENTION

Accordingly, a novel type of fabricator is provided which transforms cleanroom type designs into cleanspace designs with various unique and important improvements. In some embodiments, a cleanroom fabricator is transformed into a cleanspace fabricator. The present invention also includes methods and apparatus that may be useful in such transformations.

Building on the types of environments defined in incorporated applications, the present invention includes novel methods to form cleanspace fabricators which can process substrates of various types within the confines of existing cleanroom fabricators. As the existing cleanroom fabricators may have significant support infrastructure, albeit in some embodiments in excess of that required with a cleanspace fabricator, efficiency may derive from the reuse of structures to reposition them as newer cleanspace fabricators. Accordingly, the present invention provides description of how existing fabricators may be transformed into cleanspace fabricators.

In some embodiments of the method of transformation a ballroom design cleanroom fabricator may be transformed to a cleanspace fabricator. In a first type of embodiments, this transformation may be performed in segments of the building space at time, leaving existing space capable of continued operation. In other types of embodiments, the entire ball room may be emptied of its equipment and structural levels and then converted into a cleanspace fabricator.

In other embodiments, fabricators which are based on cleanroom designs which have operational spaces and cores for equipment may also be transformed in similar fashion.

The height of the structure may be changed in the process of transformation. In some cases the resulting structure may have a taller height, while in others the top of the cleanspace fabricator may be lower than that of the cleanroom fabricator.

The present invention can therefore include methods and apparatus for creating new cleanspace fabricators capable of processing high technology substrates of different types including fabricators designed to create semiconductor wafers, fabricators designed to create semiconductor devices which are then assembled into discrete packaged integrated circuits, and fabricators which produce high technology products which may or may not include integrated circuit manufacturing as for example, MEMS, biochip devices, solar energy components, and semiconductor substrates themselves in a non-limiting exemplary sense.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 Illustrates an exemplary starting point for cleanspace transformation based on a ballroom design.

FIG. 2 Illustrates an exemplary cross section of a ballroom fabricator and how a portion of the fabricator may be designated for transformation in some embodiments.

FIG. 3 Illustrates an exemplary cross section where a portion of the cleanroom and supporting environment have been cleared of existing entities.

FIG. 4 Illustrates an exemplary cross section when a cleanspace fabricator portion has been configured in the cleared space of the ballroom based cleanroom fabricator.

FIG. 5 Illustrates an exemplary cross section of a second portion of a cleanroom fabricator being prepared for transformation.

FIG. 6 Illustrates an example of how the cleanroom fabricator of FIG. 1 may be transformed into a cleanspace fabricator; in cross section.

FIG. 7 Illustrates an example of how the cleanroom fabricator of FIG. 1 may be transformed into a small tool cleanspace fabricator in cross section.

### DETAILED DESCRIPTION OF PREFERRED EMBODIMENTS

The present invention relates to methods and apparatus to transform existing fabricators into cleanspace fabricators. There may be numerous types of fabricators which may be transformed into a cleanspace fabricator including fabricators which are not initially designed to produce high technology devices in a cleanroom setting. Nevertheless, it is illustrative to consider examples that are based on transformation of cleanroom environments into cleanspace environments.

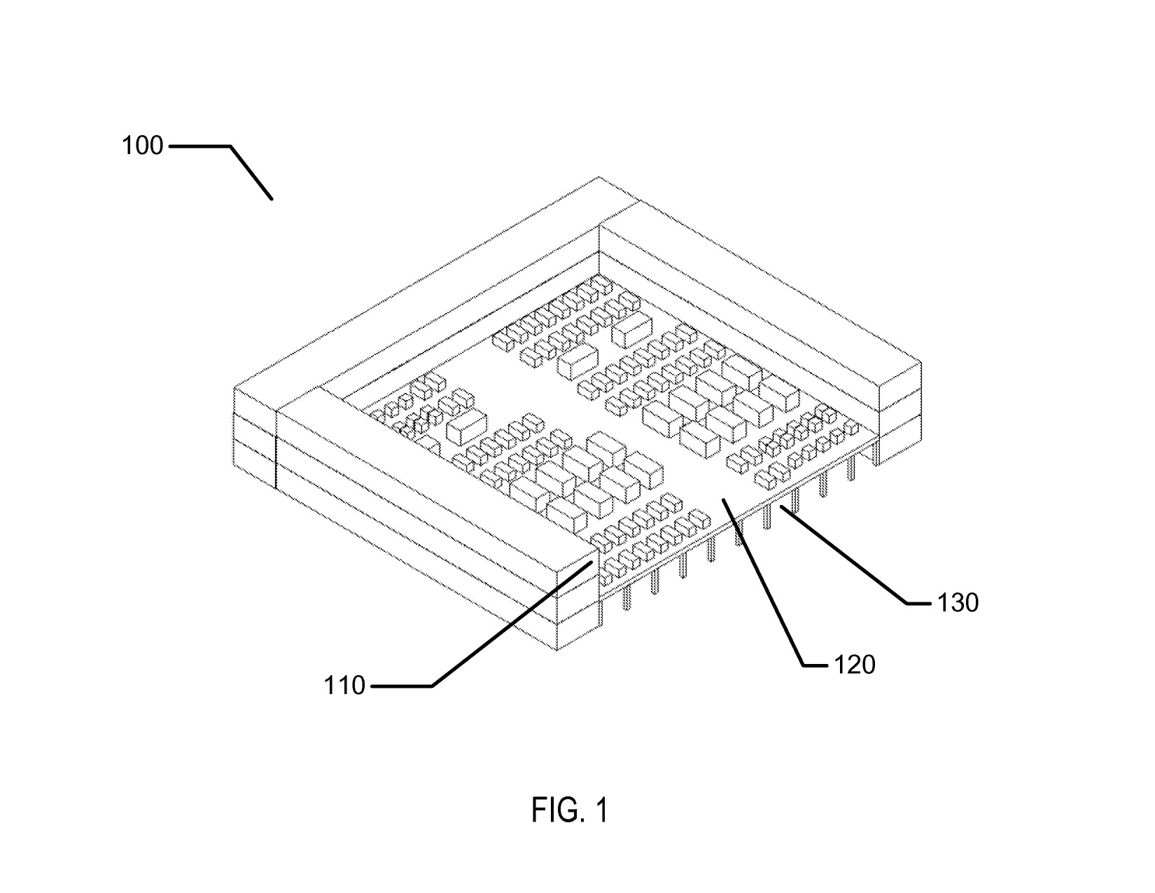

Proceeding to FIG. 1, item 100, an exemplary 3 level ballroom style cleanroom fabricator is depicted. In such a fabricator, there may be a basement floor, shown as item 130, which may contain various supporting equipment for the tooling in the cleanroom of the fabricator, item 120. The height of space 130 may exceed 20 feet in some embodiments and may be as little as a few feet; although such a size would not typically be considered a three level style. It may be apparent, that any design of a cleanroom based fabricator may be consistent with the methods to be described following and even if the fabricator cleanroom were on grade or on a slab that the techniques will be consistent with the inventive art herein.

The cleanroom space of 120 may as well be significantly tall in typical embodiments of a ballroom fabricator also exceeding 20 feet tall in some embodiments. Above the cleanroom may also be found a space, 110, which may typically contain the provision for HVAC and cleanroom airflow routing. Additionally, other types of utilities like electrical, chemical and gas conduits, signaling and information technology equipment may also be located in space 110. As mentioned before, the exact make up and size of the space above a cleanroom, like 110, may vary greatly and still be consistent with the following methods.

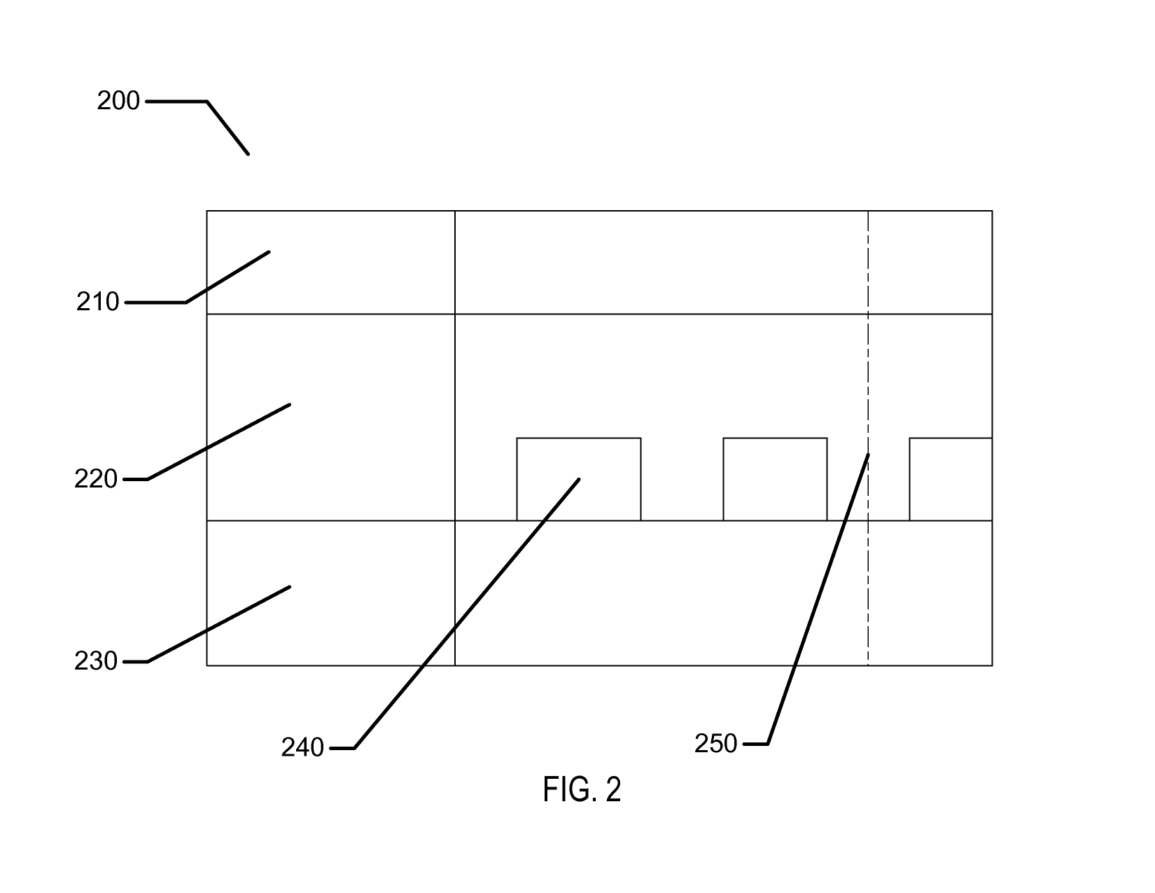

Continuing to FIG. 2, item 200 a cross section of the fabricator space of item 100 is shown. There are three initial levels to the fab as previously described. And, as shown there is a location external to the cleanroom fabricator space that also has three levels, items 210, 220 and 230. These spaces may be used for hall ways, storage facilities, utilities locations, electrical cabinets, sensing equipment and many other such uses. Item 240 depicts a tool that is located in a portion of the cleanroom space in its typical ballroom configuration. The clean room space has been partitioned by item 250, which depicts a new wall that has been installed into the fabricator. In some embodiments, the wall may simply partition space to one side or the other side of it. In other embodiments, the wall may be more sophisticated and substantial to provide support for the physical levels around it. As well various utilities, chemical lines, electrical lines etc may be routed through the new wall location in some embodiments.

In an exemplary fashion, an existing cleanroom based fabricator is retrofitted into a cleanspace fabricator by altering portions of an operating fab at a time. This is the type of embodiment that is shown in the picture. In other embodiments, the cleanroom and its processing equipment and utilities of various sorts may be dismantled creating a single large space into which the clean space fabricator may be built. Returning to the embodiment type where some portion of the fab is converted at a particular time, the space to the right of item 250 may represent the standard cleanroom based space that will continue in operation while the segment containing tool 240 may be transformed into a cleanspace fabricator space.

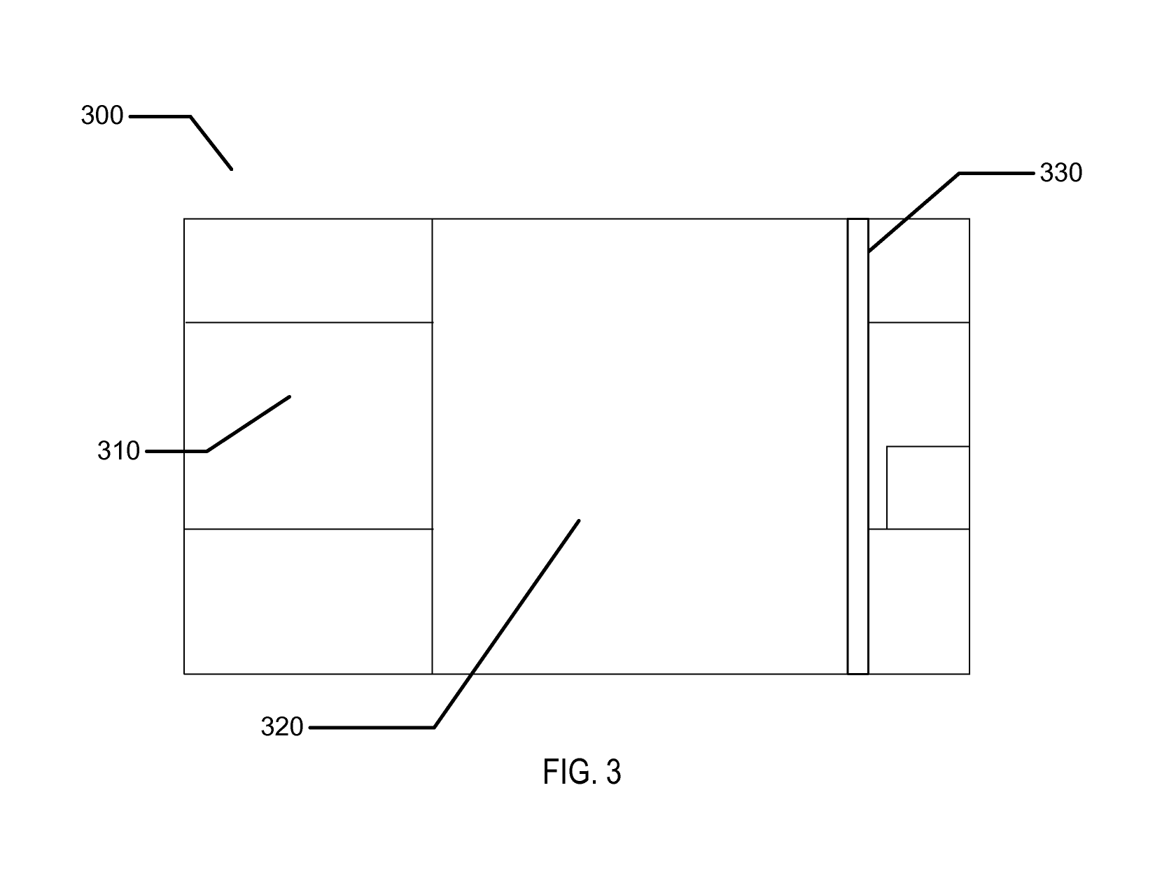

Proceeding to FIG. 3, item 300, an exemplary depiction of the clear-out of the region that has been segmented out from the rest of the cleanroom fabricator is depicted as item 320. A supporting and dividing wall is depicted as item 330 which separates the exemplary new segmented space from the original fabricator space. As described above, the wall may also perform a supporting function for the various floors and ceiling elements as the segmented space is transformed.

There are no longer the different floors and tools in the new segmented space in this exemplary depiction of steps in the method of transforming cleanroom fabricators to cleanspace fabricators. While this is one embodiment of methodology; however, there are many similar means of transformation that may be consistent within the scope of the art herein. According to the present invention, in some embodiments, one or more of the flooring or ceiling levels may be left intact, as an example. Furthermore, the nature of the cleanroom may not have three levels but a different number, for example two levels or one level. In these alternative examples the clean out may remove all aspects of the cleanroom and tooling and equipment or leave some of it if that remaining aspect is useful to the establishment of a cleanspace fabricator. As an example, the HVAC and airflow ducting into the segmented region of the fabricator in item 320 may be left after the cleanroom space is generally dismantled, since it may be useful to reuse said ducting in the operations of the cleanspace fabricator.

Item 310, of FIG. 3, depicts one of the peripheral external spaces mentioned in the exemplary cleanroom based ballroom fabricator embodiment of FIG. 1. In some embodiments this space may as well have retrofit activities performed in or upon its space. In some examples, the heights of the floors and or ceilings may be modified. In other examples there may be support equipment that is removed or placed in these spaces during the transformation process.

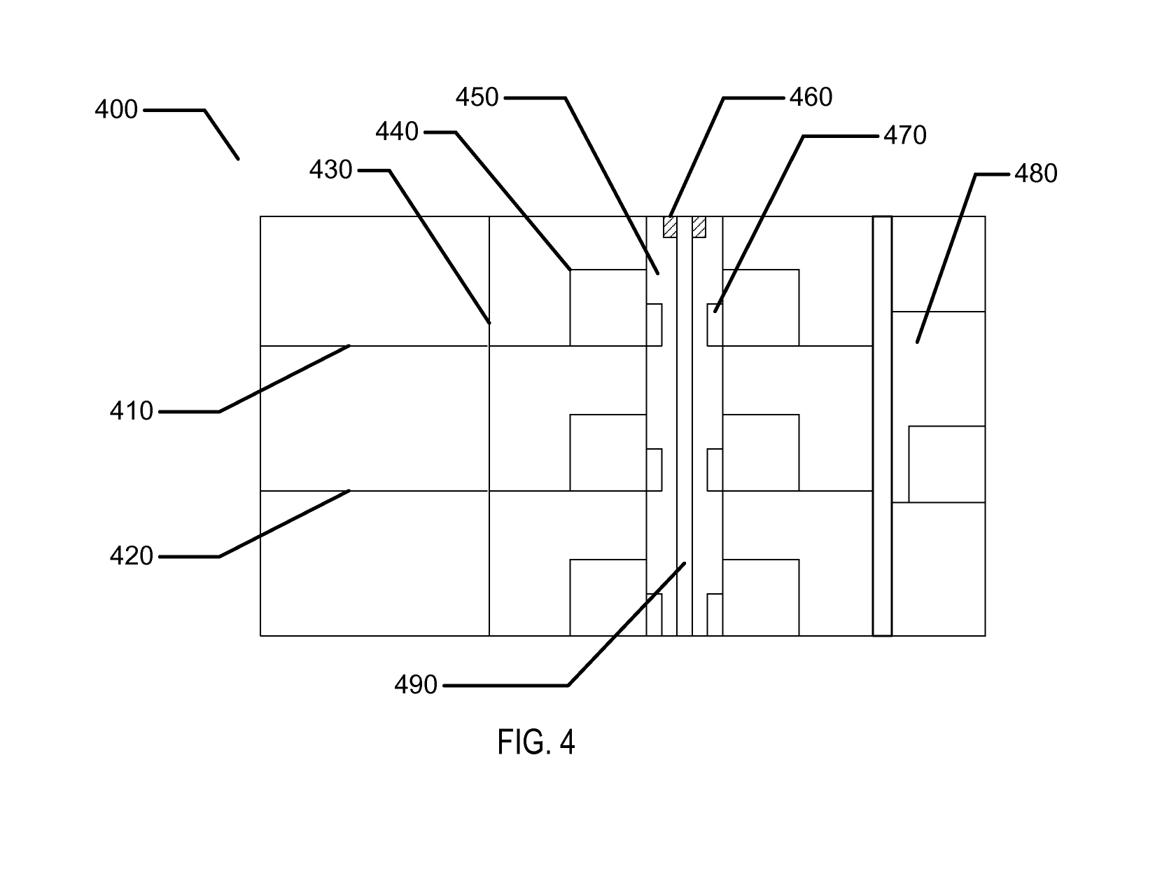

Proceeding to FIG. 4, item 400, a cleanspace fabricator may be configured as a result of the transformation of the space. There may be numerous different embodiments of a cleanspace fabricator that may comprise acceptable transformations to the original space. In the demonstrated example, essentially planar orientations of large tools; which may in some embodiments be the same size and tooling generation (I.e. Wafer size limits, lithography generation etc . . . ) while in other embodiments the tooling may be more advanced generations of tooling or for that matter less advanced generation of tooling. Item 440, depicts an exemplary new generation tool that is located in the cleanspace fabricator.

The cleanspace fabricator is shown in an example three level embodiment. It may be apparent that more or less levels are within the scope of the present invention, depending on the nature of the initial dimensions and type of cleanroom fabricator. Additionally, while the fabricator in example 400 is shown in an embodiment that has the same height as the initial fabricator; a fact which may be seen by the similar height of region 480 to the new region, in some embodiments, a cleanspace fabricator may be built to be taller than the original fabricator space or alternatively to fit into a shorter space than the original fabricator space.

Item 430 depicts a wall separating an exemplary secondary cleanspace location within the new cleanspace fabricator portion. The wall, 430, separates the secondary cleanspace from the external areas above and below the new flooring levels 410 and 420. As mentioned previously, in some embodiments there are new flooring levels that may be formed; whereas in other embodiments the same levels of the initial fabricator may be appropriate. In still further embodiments, some levels may remain the same while others are not, or while others are created or not utilized.

A new primary cleanspace location within the new cleanspace fabricator portion may be represented as item 450, for example. Within these new primary cleanspace portions substrate carriers may be moved by automation; shown for example as item 460, between different tool ports an example of which is identified as item 470. As mentioned any of the different embodiments of cleanspace fabricators may be utilized at this point, but in the exemplary depiction there may be an open location, shown as item 490 which contains two air return walls and allows for air flowing in the primary cleanspace regions, for example 450, in some embodiments to flow horizontally across the primary cleanspace region and then exit through a return air system in the 490 location. In some different embodiments, the airflow in the region 450 may be laminar, or unidirectional or non-unidirectional.

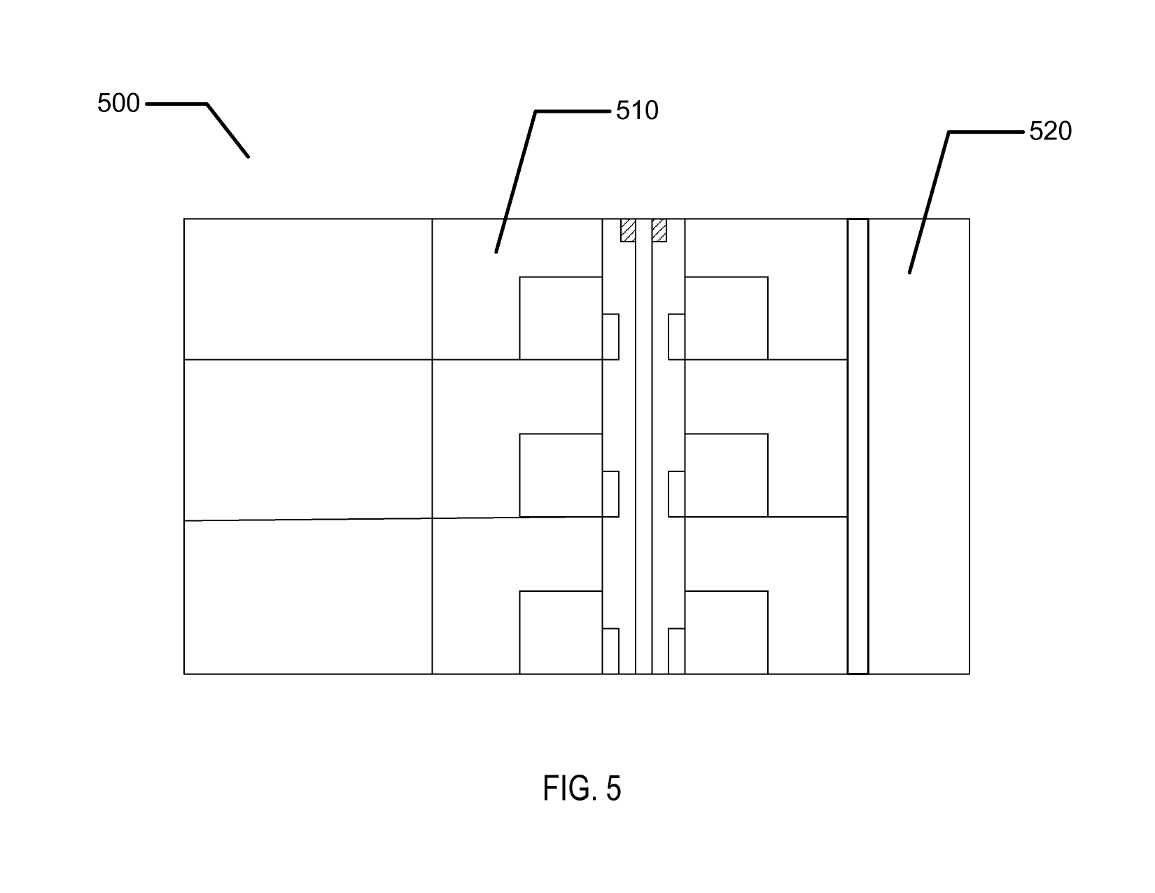

In some embodiments of the inventive art herein, the segmented portion of the cleanroom which has been transformed into a cleanspace fabricator may contain sufficient numbers of processing tooling to operate without further expansion into the fab space originally used as a cleanroom fabricator. Proceeding to FIG. 5, item 500, however, in this depiction the transformation process continues stepwise. Item 510 depicts the initially configured cleanspace while item 520 represent the next portion of the cleanroom fabricator space that may be partitioned and then dismantled to some degree as it is transformed into a clean space fabricator type.

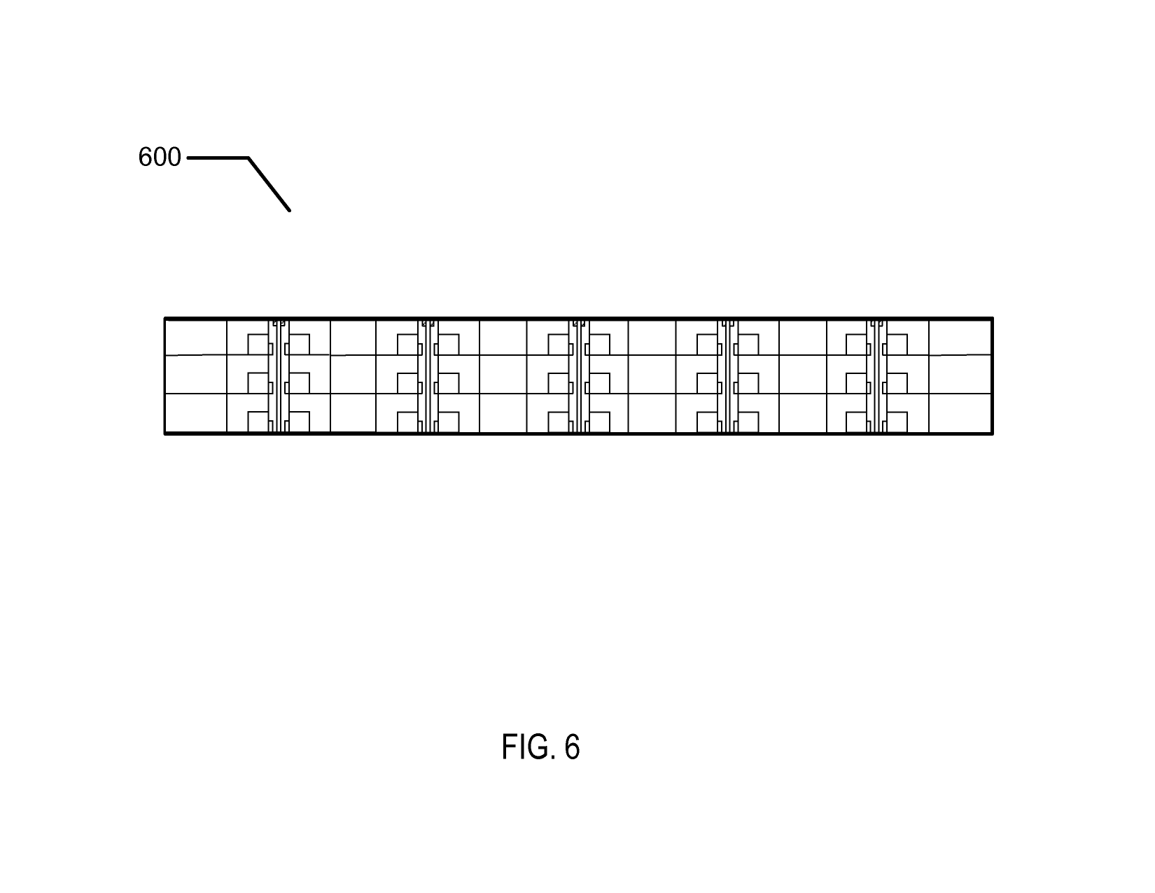

In some embodiment types, an entire existing cleanroom space may be transformed into a cleanspace fabricator. As shown as item 600, in FIG. 6, such a depiction is made. Item 600 may in some embodiments correspond to a complete transformation of the initial fabricator described as item 100; for example.

Much of the depiction of cleanspace fabricators that has been made thus far has described a cleanspace fabricator where the tools that incorporated into the cleanspace are as big as or bigger than the exemplary tools that were originally contained in the cleanroom fabricator. As has been described in incorporated descriptions, another class of cleanspace fabricators of importance may occur when the tooling incorporated is significantly smaller than the current state of the art tooling. When a cleanspace fabricator is manufactured for such smaller tooling, the actual dimensions of the fabricator may be significantly smaller than a state of the art location.

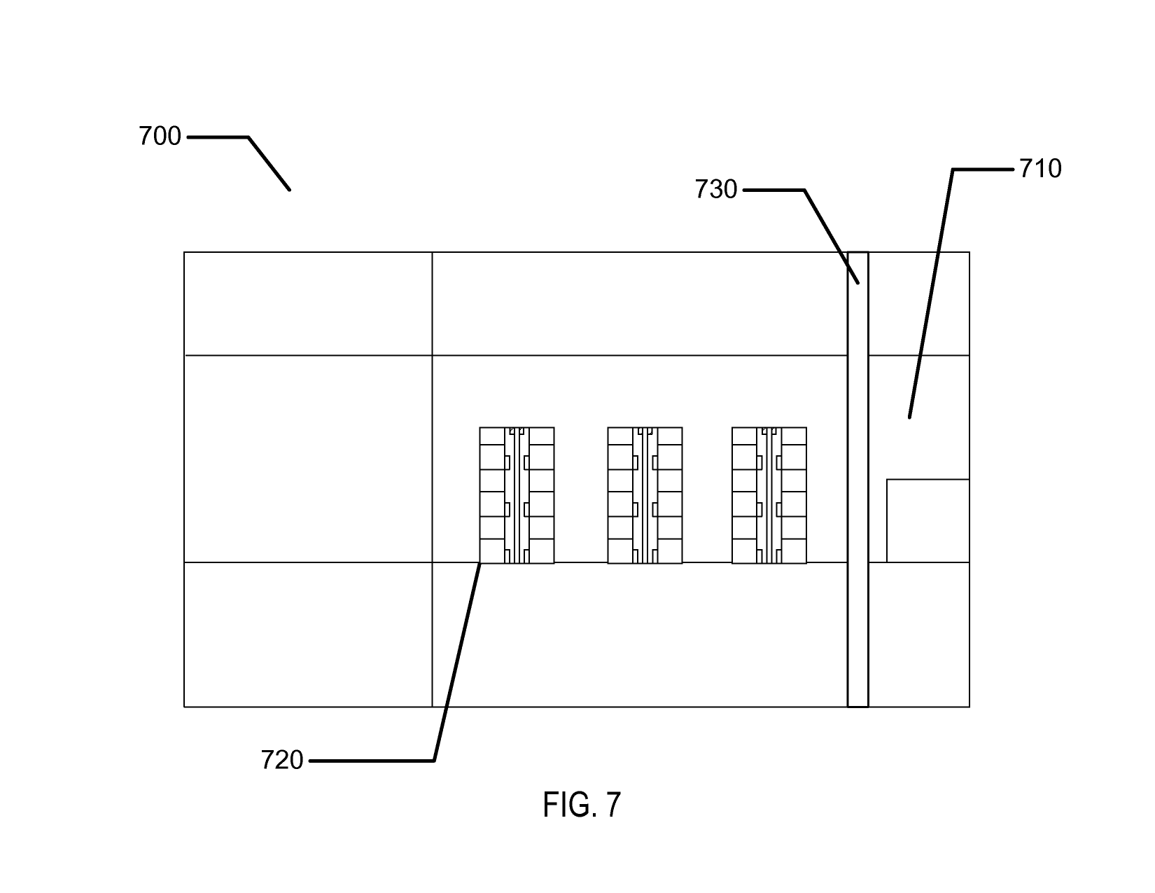

Proceeding to FIG. 7 item 700, a depiction is made where a segmented portion of an existing fabricator was transformed by the various steps and methods that have been discussed and has been then configured with small tool elements to create a cleanspace fabricator of small tooling. In the embodiment represented by FIG. 7, the new cleanspace may be created essentially into the existing cleanroom space with little change to the environment. In the demonstrated embodiment, the various elements described in FIG. 4 may be present, albeit in a smaller form factor. And the entire small tool fabricator may be located in an adjacent location to the larger classic large tool, cleanroom type ballroom fabricator shown as item 710.

There may be many different was to configure the small tool fabricator in different ways than that shown in FIG. 7. For example, the entire space from the very bottom level to the top level in a three level exemplary fab may be the height of the small tool elements; where a much higher number of tools may be configured. There may be numerous other designs that could be located in a segment of the fabricator. Additionally, item 710 may be eventually decommissioned as needed leaving just a new smaller tool fabricator design. And in still further embodiments, a very large number of small tools may be configured into a new cleanspace fabricator that is contained in the entire space as the original fabricator. And in still further diversity of embodiments, the actual size of the cleanspace fabricator may vary to larger form factors as the need dictates. Since the great number of smaller tools would fit into the original space, there may still be dividing walls such as 730 which may be useful to separate different small tool cleanspace fabricators from each other where the different fabricators in segments of the old cleanroom fabricator may produce different technologies, different substrates, different product types, or products for different customers for example.

### Processing in Transformed Cleanspace Fabricators

Some embodiments have been described where a substrate type being used in the fabricator may include a semiconductor substrate. It may be straight forward to understand how fabricators that produce semiconductors may be retrofitted into cleanspace fabricators whose function at least in part relates to production on semiconductor substrates of similar or different kinds. However, there are many other types of high technology applications that may be processed in cleanspace fabricators. For example, semiconductor substrates in wafer form may be formed in a version of a cleanspace fabricator with crystal pulling, polishing, slicing, epitaxial growth, silicon on insulator bonding and a variety of other processing types.

Cleanroom fabricators that are used to produce substrates other than semiconductors may be retrofitted according to the methods of the present invention. As a non-limiting example, some forms of compact disk manufacture are performed in cleanroom manufacturing spaces. Such a cleanroom may be retrofitted by the types of methods that have been discussed creating a cleanspace fabricator useful to produce semiconductor substrates, assembled semiconductor dice, or other non-semiconductor type of manufacturing, for example. It is alternatively possible, for example, to retrofit compact disc cleanrooms into cleanspace fabricators that are used to fabricate biologically related substrate products. Non limiting examples of such substrates may include body implant substrates as for example stents where the processing needs to be clean from a particulate perspective and from a biological perspective. Other types of biomedical devices may be built upon substrates in these types of fabricators. These biomedical devices may be sensitive to inclusion of particulate matter and biological matter and derive manufacturing benefit from the production in a cleanspace fabricator.

It may be important to note that the inventive art here within is entirely consistent in retrofitting cleanroom type fabricators into cleanspace fabricators of all these types and many others. Accordingly, the various non-semiconductor processing embodiments are consistent with the inventive art and comprise art within this scope.

### Glossary of Selected Terms

Air receiving wall: a boundary wall of a cleanspace that receives air flow from the cleanspace.

Air source wall: a boundary wall of a cleanspace that is a source of clean airflow into the cleanspace.

Annular: The space defined by the bounding of an area between two closed shapes one of which is internal to the other.

Automation: The techniques and equipment used to achieve automatic operation, control or transportation.

Ballroom: A large open cleanroom space devoid in large part of support beams and walls wherein tools, equipment, operators and production materials reside.

Batches: A collection of multiple substrates to be handled or processed together as an entity

Boundaries: A border or limit between two distinct spaces—in most cases herein as between two regions with different air particulate cleanliness levels.

Circular: A shape that is or nearly approximates a circle.

Clean: A state of being free from dirt, stain, or impurities—in most cases herein referring to the state of low airborne levels of particulate matter and gaseous forms of contamination.

Cleanspace: A volume of air, separated by boundaries from ambient air spaces, that is clean.

Cleanspace Fabricator: A fabricator where the processing of substrates occurs in a cleanspace that is not a typical cleanroom, in many cases because there is not a floor and ceiling within the primary cleanspace immediately above and below each tool body's level; before a next tool body level is reached either directly above or below the first tool body.

Cleanspace, Primary: A cleanspace whose function, perhaps among other functions, is the transport of jobs between tools.

Cleanspace, Secondary: A cleanspace in which jobs are not transported but which exists for other functions, for example as where tool bodies may be located.

Cleanroom: A cleanspace where the boundaries are formed into the typical aspects of a room, with walls, a ceiling and a floor.

Cleanroom Fabricator: A fabricator where the primary movement of substrates from tool to tool occurs in a cleanroom environment; typically having the characteristics of a single level, where the majority of the tools are not located on the periphery.

Core: A segmented region of a standard cleanroom that is maintained at a different clean level. A typical use of a core is for locating the processing tools.

Dicing: A process of cutting out segments of a substrate into smaller discrete entities sometimes called chips, dice or die.

Ducting: Enclosed passages or channels for conveying a substance, especially a liquid or gas—typically herein for the conveyance of air.

Envelope: An enclosing structure typically forming an outer boundary of a cleanspace.

Fab (or fabricator): An entity made up of tools, facilities and a cleanspace that is used to process substrates.

Fabricator Cleanspace: The portion of a cleanspace fabricator where the primary movement of substrates from tool to tool occurs; which is a primary cleanspace environment that is not a cleanroom environment; typically having the characteristics of multiple levels, where the majority of the tools are located on the periphery. When there are multiple Fabricator Cleanspaces within a single location they may be separated spatially and/or have different characteristics of the primary cleanspace such as a different ambient particle level for example.

Fit up: The process of installing into a new clean room the processing tools and automation it is designed to contain.

Flange: A protruding rim, edge, rib, or collar, used to strengthen an object, hold it in place, or attach it to another object. Typically herein, also to seal the region around the attachment.

Folding: A process of adding or changing curvature.

HEPA: An acronym standing for high-efficiency particulate air. Used to define the type of filtration systems used to clean air.

Horizontal: A direction that is, or is close to being, perpendicular to the direction of gravitational force.

Job: A collection of substrates or a single substrate that is identified as a processing unit in a fab. This unit being relevant to transportation from one processing tool to another.

Laminar Flow: When a fluid flows in parallel layers as can be the case in an ideal flow of cleanroom or cleanspace air. If a significant portion of the volume has such a characteristic, even though some portions may be turbulent due to physical obstructions or other reasons, then the flow can be characterized as in a laminar flow regime or as laminar.

Logistics: A name for the general steps involved in transporting a job from one processing step to the next. Logistics can also encompass defining the correct tooling to perform a processing step and the scheduling of a processing step.

Matrix: An essentially planar orientation, in some cases for example of tool bodies, where elements are located at discrete intervals along two orthogonal axes directions.

Multifaced: A shape having multiple faces or edges.

Nonsegmented Space: A space enclosed within a continuous external boundary, where any point on the external boundary can be connected by a straight line to any other point on the external boundary and such connecting line would not need to cross the external boundary defining the space.

Perforated: Having holes or penetrations through a surface region. Herein, said penetrations allowing air to flow through the surface.

Peripheral: Of, or relating to, a periphery.

Periphery: With respect to a cleanspace, refers to a location that is on or near a boundary wall of such cleanspace. A tool located at the periphery of a primary cleanspace can have its body at any one of the following three positions relative to a boundary wall of the primary cleanspace: (i) all of the body can be located on the side of the boundary wall that is outside the primary cleanspace, (ii) the tool body can intersect the boundary wall or (iii) all of the tool body can be located on the side of the boundary wall that is inside the primary cleanspace. For all three of these positions, the tool's port is inside the primary cleanspace. For positions (i) or (iii), the tool body is adjacent to, or near, the boundary wall, with nearness being a term relative to the overall dimensions of the primary cleanspace.

Planar: Having a shape approximating the characteristics of a plane.

Plane: A surface containing all the straight lines that connect any two points on it.

Polygonal: Having the shape of a closed figure bounded by three or more line segments.

Process: A series of operations performed in the making or treatment of a product—herein primarily on the performing of said operations on substrates.

Robot: A machine or device that operates automatically or by remote control, whose function is typically to perform the operations that move a job between tools, or that handle substrates within a tool.

Round: Any closed shape of continuous curvature.

Substrates: A body or base layer, forming a product, that supports itself and the result of processes performed on it.

Tool: A manufacturing entity designed to perform a processing step or multiple different processing steps. A tool can have the capability of interfacing with automation for handling jobs of substrates. A tool can also have single or multiple integrated chambers or processing regions. A tool can interface to facilities support as necessary and can incorporate the necessary systems for controlling its processes.

Tool Body: That portion of a tool other than the portion forming its port.

Tool Port: That portion of a tool forming a point of exit or entry for jobs to be processed by the tool. Thus the port provides an interface to any job-handling automation of the tool.

Tubular: Having a shape that can be described as any closed figure projected along its perpendicular and hollowed out to some extent.

Unidirectional: Describing a flow which has a tendency to proceed generally along a particular direction albeit not exclusively in a straight path. In clean airflow, the unidirectional characteristic is important to ensuring particulate matter is moved out of the cleanspace.

Unobstructed removability: refers to geometric properties, of fabs constructed in accordance with the present invention that provide for a relatively unobstructed path by which a tool can be removed or installed.

Utilities: A broad term covering the entities created or used to support fabrication environments or their tooling, but not the processing tooling or processing space itself. This includes electricity, gasses, airflows, chemicals (and other bulk materials) and environmental controls (e.g., temperature).

Vertical: A direction that is, or is close to being, parallel to the direction of gravitational force.

While the invention has been described in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

What is claimed is:

1. A method of producing cleanspace fabricators, said method comprising the steps of:
removing at least a first portion of processing tools from a first cleanroom fabricator;
isolating a portion of a first cleanroom fabricator with at least a first cleanspace wall, wherein the isolated portion comprises an area occupied by the first portion of processing tools that has been removed from the first cleanroom fabricator;
configuring flooring levels consistent with a cleanspace fabricator;
fixing multiple substrate processing tools in a first matrix comprising at least two of the processing tools oriented in a vertical dimension in relation to each other wherein said multiple processing tools are at least partially located in a fabricator cleanspace comprising a first boundary and a second boundary and each of the processing tools is capable of independent operation and removable in a discrete fashion relative to other processing tools.

2. The method of claim 1 additionally comprising:
storing at least a first substrate in a carrier while the substrate is transported between two or more of the processing tools;
receiving the substrate carrier into a first processing tool port, wherein each tool is sealed to a respective opening in at least one of the first boundary and the second boundary;
removing the substrate from the cleanspace comprising the substrate carrier into a cleanspace comprising the first tool port; performing a first process on the substrate in the first tool;
containing the substrate in the substrate carrier subsequent to the performance of the first process; transporting the substrate carrier to a second tool port;
removing the substrate from the cleanspace comprising the substrate carrier into a cleanspace comprising the second tool port; and
performing a second process on the substrate in the second tool.

3. The method of claim 2 additionally comprising:
fixing a second set of multiple substrate processing tools in a second matrix comprising at least two of the second processing tools oriented in a vertical dimension in relation to each other wherein said multiple processing tools are at least partially located in a second fabricator cleanspace comprising a third boundary and a fourth boundary and each of the processing tools is capable of independent operation and removable in a discrete fashion relative to other processing tools;
removing the substrate carrier from the first fabricator cleanspace;
placing the substrate carrier into the second fabricator cleanspace.

4. A method of forming a cleanspace fabricator, said method comprising:
Removing processing tools from a first cleanroom fabricator;
configuring flooring levels consistent with a cleanspace fabricator;
fixing multiple substrate processing tools in a first matrix comprising at least two of the processing tools being oriented in a vertical dimension in relation to each other wherein said multiple processing tools are at least partially located in a fabricator cleanspace comprising a first boundary and a second boundary and each of the processing tools is capable of independent operation and removable in a discrete fashion relative to other processing tools;

5. The method of claim 4 additionally comprising:
storing at least a first substrate in a carrier while a substrate is transported between two or more of the processing tools;
receiving the substrate carrier into a first processing tool port, wherein each tool is sealed to a respective opening in at least one of the first boundary and the second boundary;
removing the substrate from the substrate carrier into a first tool port;
performing a first process on the substrate in the first tool;
containing the substrate in the substrate carrier subsequent to the performance of the first process; transporting the substrate carrier to a second tool port;
removing the substrate from the substrate carrier into a second tool port; and
performing a second process on the substrate in the second tool.

6. The method of claim 5 additionally comprising:
fixing a second set of multiple substrate processing tools in a second matrix comprising at least two of the second processing tools oriented in a vertical dimension in relation to each other wherein said multiple processing tools are at least partially located in a second fabricator cleanspace comprising a third boundary and a fourth boundary and each of the processing tools is capable of independent operation and removable in a discrete fashion relative to other processing tools;
removing the substrate carrier from the first fabricator cleanspace;
placing the substrate carrier into the second fabricator cleanspace.

7. A method of producing cleanspace fabricators ; said method comprising:
removing at least a first portion of processing tools from a first cleanroom fabricator;
isolating the portion of a first cleanroom fabricator where the first portion of processing tools has been removed from the rest of the first cleanroom fabricator with at least a first cleanspace wall;
configuring tooling support levels consistent with a cleanspace fabricator within the cleanroom fabricator;
fixing multiple substrate processing tools in a first matrix comprising at least two of the processing tools oriented in a vertical dimension in relation to each other wherein said multiple processing tools are at least partially located in a fabricator cleanspace comprising a first boundary and a second boundary and each of the processing tools is capable of independent operation and removable in a discrete fashion relative to other processing tools.

8. The method of claim 7 additionally comprising:
storing at least a first substrate in a carrier while a substrate is transported between two or more of the processing tools;
receiving the substrate carrier into a first processing tool port, wherein each tool is sealed to a respective opening in at least one of the first boundary and the second boundary;
removing the substrate from the substrate carrier into a cleanspace comprising the first tool port; performing a first process on the substrate in the first tool;
containing the substrate in the substrate carrier subsequent to the performance of the first process; transporting the substrate carrier to a second tool port;
removing the substrate from the substrate carrier into a second tool port; and
performing a second process on the substrate in the second tool.

9. The method of claim 8 additionally comprising:
fixing a second set of multiple substrate processing tools in a second matrix comprising at least two of the second processing tools being oriented in a vertical dimension in relation to each other wherein said multiple processing tools are at least partially located in a second fabricator cleanspace comprising a third boundary and a fourth boundary and each of the processing tools is capable of independent operation and removable in a discrete fashion relative to other processing tools;
removing the substrate carrier from the first fabricator cleanspace;
placing the substrate carrier into the second fabricator cleanspace.
